(19) United States
(12) Patent Application Publication
(10) Pub. No.: US 2024/0176692 A1
(43) Pub. Date: May 30, 2024

(54) Method And System For Self-Healing Applications By Means Of Automatic Analysis Of Log Sources

(71) Applicant: German Edge Cloud GmbH & Co. KG, Eschborn (DE)

(72) Inventors: Mauricio Fadel ARGERICH, Heidelberg (DE); Simon TSCHÖKE, Darmstadt (DE); Arne SCHMIEG, Burgwedel (DE); René BRINKHEGE, Dortmund (DE)

(21) Appl. No.: 18/517,850

(22) Filed: Nov. 22, 2023

(30) Foreign Application Priority Data
Nov. 24, 2022 (DE) 102022131127.9

(51) Int. Cl. G06F 11/07

(52) U.S. Cl. CPC G06F 11/0793; G06F 11/0709

(57) ABSTRACT

A computer-implemented method including determining anomalies in one or more log sources of a system; and determining and correcting the causes for each of the anomalies by querying a database which maps previously known causes to respective solution actions, and by applying the queried solution actions to the system. The invention further relates to a system, having one or more log sources; a processor on which an application runs which is configured to carry out the method.

### CROSS-REFERENCE TO RELATED APPLICATIONS

This application claims the benefit and priority to German Patent Application No. 10 2022 131 127.9 filed Nov. 24, 2022. The entire disclosure of the above application is incorporated herein by reference.

### TECHNICAL FIELD

The present invention is in the technical field of automatic analysis of log sources and the use of results of such analyses for correcting errors in a computer system.

### BACKGROUND

Many applications on computer systems generate log sources (e.g. log files, log streams, etc.) in which they collect status messages of their operation. These applications comprise both user applications, such as text processing programs, calculation programs, messaging clients, as well as system applications, such as operating systems, daemons, web servers, email servers. A log source may contain either the messages of a single application or the messages of multiple different applications. Log sources are an important source for determining malfunctions of the applications. Such malfunctions comprise, for example, problems when reading or writing files (file not present or memory depleted), problems when contacting servers or clients (no network connection or server/client not started; no answer from server/client), etc. Such malfunctions manifest themselves in log sources as error messages; these are also referred to here as anomalies.

Log sources are usually reviewed by a user or administrator of a system in order to find anomalies and other indications of a malfunction. In order to determine a corresponding action for restoring the affected application for an anomaly found in a log source, a further search is often required, for example a web search or a study of operating instructions. This process is complex and cost-intensive. Measures for automatically searching log sources for conspicuous messages are known in the prior art. However, a completely automatic solution for restoring defective applications is hitherto unknown.

### SUMMARY

Determining anomalies in one or more log sources of a system; and determining and correcting the causes for each of the anomalies by querying a database that maps pre-known causes to respective solution actions and applying the queried solution actions to the system.

Embodiments of the invention also comprise systems comprising: one or more log sources; a processor running an application configured to perform the method of any preceding claim.

Further embodiments are defined in the appended claims.

### BRIEF DESCRIPTION OF THE DRAWINGS

FIG. 1 shows a method according to the invention.

### DETAILED DESCRIPTION

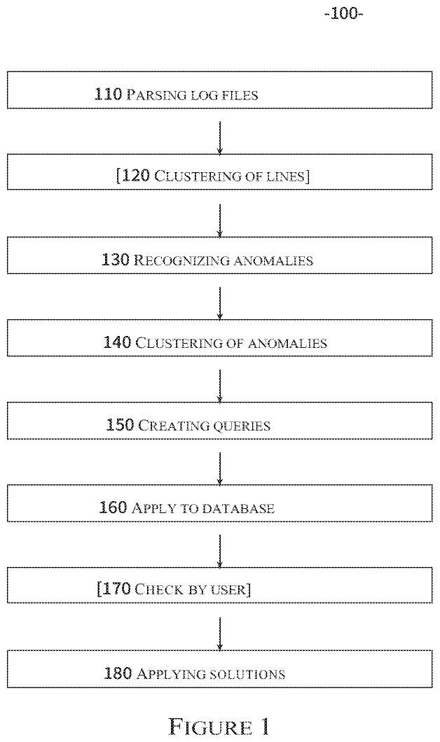

FIG. 1 shows a computer-implemented method 100 for automatic restoration of a defective application which stores status messages in one or more log sources. In step 110, the log sources are parsed. This step, and thus the entire method 100, can be initiated manually by a user or administrator, for example by calling up a corresponding program on a system on which the application is running or is to run. Alternatively, the method 100 can also be started automatically, for example by a daemon or other process which continuously monitors the applications running on the system and takes conspicuous patterns of these applications as the reason for performing the method according to the invention. Such monitoring can comprise observing the time periods between the start and the end of an application; the method 100 is started when an application ends again within a predefined (short) time period after the start. Alternatively, the monitoring can comprise observing the memory consumption (main memory) of the application; the method 100 is started when the memory consumption exceeds a predefined frame or a predefined increase rate. In addition, it can be checked whether application is started more frequently than a predefined value within a predefined time period.

Step 110 comprises determining structures of the messages contained in the log source. Such messages contain, on the one hand, recurring static/constant text elements and, on the other hand, dynamically generated text elements; for example, a message can contain, on the one hand, the name of a parameter and, on the other hand, a current parameter An example of a message can be:
(1) “Receiving block blk_-1608999687919862906 src: /10.250.19.102:54106 dest: /10.250.19.102:50010”

In this example, step 110 can comprise identifying and designating recurring (static or constant) text elements and dynamically generated text elements as such. In the example reproduced, the text element can be called “Receiving block [ . . . ] src: [ . . . ] dest:” and the dynamically generated text elements “blk_-1608999687919862906” and “dest: /10.250.19.102:50010”. In an exemplary embodiment, this result can be obtained from the comparison with other rows of the log source. Thus, this can additionally contain the following row:
(2) “Receiving block blk_-1608999687919862906 src: /10.250.10.6:40524 dest: /10.250.10.6:50010”

By comparing row (1) with row (2) and/or similar formatted rows, it is possible to determine which text elements are static and which have been dynamically generated, for example by determining the identical and the different components of both rows. Further examples of dynamically generated text elements are time, IP address, name of a process, transmission rates, etc.

Log sources usually also contain rows with different constant text elements. Thus, the mentioned log source can additionally contain the following row:
(3) “Received block blk_-1608999687919862906 of size 91178 from /10.250.10.6”

Row (3) contains the constant text element “Received block [ . . . ] of size [ . . . ] from [ . . . ]”, which differs from the constant text elements determined above. In addition to the differentiation between constant and dynamic components of a row, step 110 can therefore also comprise a differentiation of different constant components. A row can be assigned to a type using the different constant components. For example, rows (1) and (2) can be assigned to a first type “A” on the basis of their identical constant component, and row (3) can be assigned to a second type “B” on the basis of its different constant component.

In one embodiment, step 110 can comprise assigning the messages in the log source to individual applications. This is only required if a log source is actually described by different applications. An example of such a log source is “syslog” on Linux systems. The assignment can also be advantageous if, although only one application writes to a log source, it produces messages of different applications. Normally, in such multiple descriptions, the name of the application in question is indicated in each row of the log source. As a result, step 110 provides collections sorted by applications about messages and information about the structure of these messages, such as the described constant and dynamically generated text elements.

In a log source, a plurality of rows can relate to an identical situation. Thus, an application can contain error messages about a timeout of a (physical) client and consequently also about a timeout of a local process which does not receive input data, for example on the basis of a lack of network connection. In one embodiment, the method 100 comprises an optional step 120 which combines different rows of the log source into common clusters. For example, in step 120, different constant text elements can be determined which always occur successively or at a predetermined distance from one another in the log source. Alternatively, or additionally, dynamically generated text elements can be identified which occur identically in a plurality of text elements, for example a session ID. By means of such clusters, rows can be determined which semantically belong together, for example to a common session of a user or to a common process (network access).

The method 100 contains a further step 130 for detecting anomalies. For this purpose, from the rows of the log source (alternatively: from the determined clusters) and their time of arrival stamps, vectors are generated whose elements reproduce properties of the rows, respectively the clusters. For example, the vector elements can contain numerical values which identify the static text elements outlined above, respectively reproduce the dynamically generated text elements. More generally, the vector elements can be generated by means of a mapping function of text components, i.e. words or phrases or numbers, onto numerical values. The vectors are used as input for an ML model which classifies and/or correspondingly marks the vectors, and thus the underlying clusters, respectively rows, as “normal” or “abnormal”. As ML model, known mechanisms from artificial intelligence come into consideration, in particular neural networks. The concrete selection and structure of such a model is in the favor of the person skilled in the art. The decision as to whether a cluster or a row is designated as normal or not can be made, for example, using certain keywords, for example “failed”, “repeated”, “cannot”, “warning”, “stopped”, “unavailable”, etc. The decision can also be based on numerical values or other dynamically generated text elements assuming values outside their intended value range, for example “−1”, “nan”, “NULL”, etc. Rows of the same type (for example type “A”) can also be compared with one another in order to determine usual value ranges of the contained dynamic text components and to assess outliers in these rows.

In a further step 140, the anomalies (“abnormal”) identified in step 130 are subjected to a further clustering. For this purpose, all already considered clusters or rows are combined into clusters with respect to certain commonalities independently of their marking as “normal” or “abnormal”. For example, clusters or rows can be combined on the basis of temporal proximity, that is to say for example all clusters/rows that lie within a certain temporal radius starting from a certain time of a cluster can be combined. The determination of a central time and a radius for a cluster lies in the range of usual measures of known cluster algorithms. In addition or alternatively to a time-based clustering, the clustering can be based on a granularity (verbosity) of the contained messages. This is based on the knowledge that applications usually output more information in the case of a malfunction than in normal operation. This can manifest itself in a high number of reported parameters per row or cluster. By means of a corresponding clustering, those clusters and/or rows can be combined whose granularity—that is to say for example row lengths, number of parameters, number of words—is similar to one another, that is to say lies within a common range.

The method 100 continues at step 150. For each of the last generated clusters, step 150 generates a natural language query designating the anomaly of this cluster. Such a query can contain one or more terms characterizing the anomaly. In one embodiment, this query can be compiled using a data structure containing predefined terms, for example “excessive memory usage”, “connection timeout”, “unresponsive”, etc. The data structure can map these terms to specific properties of corresponding anomalies, for example the criteria used in step 140 for clustering clusters/rows, or criteria derived therefrom, for example specific words contained in the clusters, their frequency within a cluster or the size of a cluster.

In step 160, the query generated in step 150 is applied to a database. The database contains a collection of known anomalies as well as possibly known actions (instructions or programs) for solving them. The anomalies and actions can also be stored in the form of natural language questions and answers. In one embodiment, a search engine in the Internet can be used as database. When applying the query to the database, relevant anomalies are identified using words of the query.

In one embodiment, a further step 170 can optionally be carried out in which the results of the query are presented to a user or administrator on a display of the system. The representation contains, on the one hand, the determined anomaly, possibly with details of the anomaly or reasons that led to its classification, and, on the other hand, the solution proposals found. The user is given the possibility of selecting or rejecting solutions and configuring selected solutions by means of graphical user elements. The user can also replace a proposed solution with another solution or, in the case of a missing solution (only the anomaly is shown), define his own solution, for example by entering a solution path or by selecting an application for solving the problem.

In step 180, the method 100 applies the determined, respectively selected or revised/supplemented measures to the system. If the determined measures have been changed or supplemented by the user in step 170, step 180 can comprise storing these changed measures in the database in order to use them in future executions of the method 100. For this purpose, step 180 compares the measure intended for execution with the measure currently stored in the database in order to determine whether this had been changed. The re-storing of a changed measure can also comprise a feedback by the user; in this case, the differences between the previously stored measure and the configured/supplemented measure are illustrated to the user and the opportunity for a confirmation is given. The method 100 then applies the measure. This application can comprise executing a concrete software. Alternatively, the application can comprise guiding the user through a plurality of steps, for example by representing each step, for example opening a file, changing a variable, restarting a program, installing an application, updating an installed application, etc. In this case, each step can be confirmed by the user after its execution, so that the next step is displayed.

The method can be supplemented or varied by the following further embodiments.

In one embodiment, the method 100 independently selects from a plurality of available log sources those which are relevant for a malfunction. For example, the method, as described, can be started automatically on account of an observed anomaly, for instance on account of excessive memory consumption. For analysis, the method selects only those log sources which are described by applications to which the memory consumption is attributed. For example, the method determines, using system information of the operating system, that a particular application consumes more memory than is permissible according to a threshold value for this application, and retrieves the paths of all log sources which are described by this application. The paths can be read from a data structure which was created in advance for this purpose, or can be retrieved from parameters of applications, for example from a registry (Microsoft Windows) or from packet information (Linux distributions). The method 100 is then restricted to the analysis of the log sources thus determined.

In one embodiment, the method also analyzes log sources with regard to whether further applications whose log messages are not written into the analyzed log sources can also be the cause of the malfunction, and independently includes the log sources of such applications in the analysis. For example, excessive memory consumption of an application can be attributed to the application starting further applications or processes which use further log sources. Such dependent applications can be determined, for example, by a process tree; the operating system usually notes in such a process tree those processes or applications which start other processes. The log sources of dependent processes can, as described, be determined by registry or packet information.

The invention further comprises systems suitable for carrying out the method described here, as well as computer-readable media storing instructions which, when executed by a processor, carry out the methods described here. Systems for carrying out the methods described here comprise, for example, commercially available computers, mobile devices, telephones, etc., which have software and/or hardware configured to carry out the methods.

What is claimed is:

1. A computer-implemented method comprising:
determining anomalies in one or more log sources of a system; and
determining and correcting the causes for each of the anomalies by querying a database that maps pre-known causes to respective solution actions and applying the queried solution actions to the system.

2. The method of claim 1, wherein determining anomalies comprises:
converting texts stored in the log sources into structured data, wherein components of the texts are classified with respect to their underlying events and their parameters are determined, and wherein the structured data differentiates into constant components of the texts from variable components of the texts.

3. The method of claim 1, wherein determining anomalies comprises:
clustering rows of the log sources using common identifiers used in different rows;
determining parameter values from the clusters; and
converting the clusters into respective number vectors.

4. The method of claim 1, wherein determining anomalies comprises:
converting rows of the log sources and their time of arrival stamps into respective number vectors.

5. The method of claim 3, wherein determining anomalies comprises:
training a machine learning, ML, model using the number vectors, wherein a label designating the cluster/row as normal or abnormal is created for each cluster/row, respectively.

6. The method of claim 1, further comprising:
clustering the anomalies according to the time of their occurrence and/or according to the content of the underlying rows, the logging granularity, the generating component.

7. The method of claim 6, further comprising:
for each of the clusters of the anomalies, generating a natural language query that labels the respective anomaly, wherein the generating comprises examining words in the clusters of the anomalies with respect to their frequency within a cluster, the frequency in all clusters of the log sources, respectively all rows of the log sources, and the granularity of the words, and mapping the most frequent words thus determined to natural language sentences.

8. The method of claim 7, further comprising:
applying the natural language query to a database to obtain actions for correcting the respective anomaly, wherein the database contains natural language questions regarding anomalies as well as corresponding answers, in particular wherein the answers comprise technical steps for resolving the respective anomalies and/or prepared applications.

9. The method of claim 8, further comprising:
presenting the answers stored for the anomalies in the database to a user of the system;
receiving a selection of the answers; and
applying the selected answers to the system.

10. A system comprising:
one or more log sources;
a processor running an application configured to perform the method of claim 1.
